(19) United States
(12) Patent Application Publication
(10) Pub. No.: US 2026/0168935 A1
(43) Pub. Date: Jun. 18, 2026

(54) UNIVERSAL GEMSTONE CUT IDENTIFICATION DEVICE AND METHOD

(71) Applicants: POSTECH RESEARCH AND BUSINESS DEVELOPMENT FOUNDATION, Pohang-si (KR); MAX PLANCK POSTECH/KOREA RESEARCH INITIATIVE, Pohang-si (KR)

(72) Inventors: Jae Hoon PARK, Pohang-si (KR); Jae Yu KIM, Pohang-si (KR)

(73) Assignees: POSTECH RESEARCH AND BUSINESS DEVELOPMENT FOUNDATION, Pohang-si (KR); MAX PLANCK POSTECH/KOREA RESEARCH INITIATIVE, Pohang-si (KR)

(21) Appl. No.: 19/127,687

(22) PCT Filed: Nov. 11, 2022
(86) PCT No.: PCT/KR2022/017719

§ 371 Date: May 6, 2025

(51) Int. Cl. G01N 21/87; G01N 21/47

(52) U.S. Cl. CPC G01N 21/87; G01N 21/47; G01N 2021/4723; G01N 2201/1087

(57) ABSTRACT

A method for universally identifying gemstone cuts is provided. The method includes mounting a cut gemstone sample on a gemstone sample support, irradiating a laser beam onto a boundary between a first surface and a second surface of a measurement target gemstone, and measuring an angle between the first surface and the second surface based on an angular difference between a first diffraction component and a second diffraction component of the laser beam diffracted from the boundary.

### CROSS-REFERENCE TO RELATED APPLICATIONS

This is a U.S. national stage of PCT International Application No. PCT/KR2022/017719, filed on Nov. 11, 2022, the entire contents of which are incorporated herein by reference for all purposes.

### TECHNICAL FIELD

The present disclosure relates to gemstone identification, and more particularly, to a device and method for a universal gemstone cut identification.

### DESCRIPTION OF RELATED ART

For example, gemstones such as diamonds may be evaluated and graded by various evaluation criteria and their value may be determined. In this regard, diamonds are the hardest substance on Earth and have a high refractive index, so they have high reflectivity when polished and beauty due to the light scattering effect, making them the most expensive gemstone material.

Recently, with the development of mining technology, not only has the number of natural diamonds being mined increased, but also the production technology of artificial diamonds has improved. Research on synthetic methods to replace expensive natural diamonds has been conducted for several decades. Recently, synthetic diamonds have been produced by HPHT (high temperature, high pressure) and CVD (chemical vapor deposition) methods, and since the first synthetic diamond was produced in the 1950s, many technological advancements have made it possible to synthesize colorless and transparent 10 CTS grade diamonds.

In this way, both natural and synthetic diamonds are expected to continue to increase in the production and distribution of gemstones. In relation to this, regarding the evaluation and appraisal procedures of diamonds, there has been a continuous debate about the closed appraisal and distribution process, and the need for own appraisal technology has emerged. The existing traditional appraisal methods require skilled workers, and there has been controversy over repetition and fairness.

In relation to this, as a conventional evaluation method, diamond appraisal methods such as enlarged analysis using an optical microscope, Fourier transform infrared spectroscopy (FT-IR), UV-VIS-NIR, PL (Photoluminescence), and Raman analysis have been attempted. In the case of enlarged analysis using an optical microscope, observation is performed under dark field illumination, which allows for good observation of inclusions within the diamond. In synthetic diamonds, metal inclusions due to metal catalysts required during synthesis, and internal graining due to lattice structure defects may be found.

Fourier transform infrared spectroscopy (FT-IR) is the most effective analytical instrument for identifying the type of diamond. The types of diamonds are largely classified into Type I and Type II, and the biggest difference between them is the presence or absence of nitrogen. In colorless diamonds, natural Type II diamonds account for about 0.5% of the production, and the rest are all Type I diamonds.

PL (Photoluminescence) is an analysis method that uses the principle of fluorescence to analyze the light energy absorbed and emitted by the transition between the unique electronic states within a material. In the case of CVD synthesis, when excited at a wavelength of 635 nm, doublet peaks due to SiV may be observed at 736.6 nm and 736.9 nm.

Raman spectroscopy is a method to confirm the state of a substance by observing the Raman phenomenon in which a wavelength of a different form from the emitted energy is scattered when energy is emitted into a molecule undergoing its own vibrational motion.

Appraisal methods such as magnified analysis using an optical microscope, Fourier transform infrared spectroscopy (FT-IR), UV-VIS-NIR, PL (Photoluminescence), and Raman analysis have only been used to distinguish between natural and synthetic diamonds, and have not been able to grade diamonds through evaluation and appraisal.

In relation to this, there have been attempts at automated evaluation as an appraisal method capable of evaluating the grade of a gemstone, unlike traditional evaluation methods. However, a 3D morphology-based technology, which is a similar automated technology, requires considerably expensive equipment for implementation and has the problem of requiring a large amount of computation.

### SUMMARY

In order to solve the above-mentioned problems, an object of the present disclosure is to provide a method for universally identifying gemstone cuts that enables quantitative and numerical evaluation of gemstone cutting by measuring an angle between cut surfaces of a gemstone using a diffraction analysis principle, thereby allowing the angle between the measurement target surfaces of the gemstone to be measured with only low-cost equipment and simplified computation.

In order to solve the above-mentioned problems, another object of the present disclosure is to provide a universal gemstone cut identification device that enables quantitative and numerical evaluation of a gemstone cutting by measuring an angle between cut surfaces of a gemstone using a diffraction analysis principle, thereby allowing the angle between the measurement target surfaces of the gemstone to be measured with only low-cost equipment and simplified computation.

However, the problem to be solved by the present disclosure is not limited thereto, and may be expanded in various ways without departing from the spirit and scope of the present disclosure.

In order to achieve the above-described objects, according to one embodiment of the present disclosure, there is provided a method for universally identifying gemstone cuts including: mounting a cut gemstone sample on a gemstone sample support; irradiating a laser beam onto a boundary between a first surface and a second surface of a measurement target gemstone; and measuring an angle between the first surface and the second surface based on an angular difference between a first diffraction component and a second diffraction component of the laser beam diffracted from the boundary.

According to one aspect, the gemstone sample support may be a 4-axis rotating device having four rotation axes including a theta rotation axis, a 2-theta rotation axis, a chi rotation axis, and a phi rotation axis.

According to one aspect, the theta rotation axis and the 2-theta rotation axis may be configured to rotate about the same axis, the chi rotation axis may be orthogonal to the theta rotation axis, and the phi rotation axis may pass through an intersection point of the theta rotation axis and the chi rotation axis and may be orthogonal to the chi rotation axis.

According to one aspect, a beam sensor for detecting the laser beam may be mounted on a 2-theta rotating body that rotates about the 2-theta rotation axis.

According to one aspect, 2-theta rotation about the 2-theta rotation axis may be performed independently of the rotation about the theta rotation axis, the chi rotation axis, and the phi rotation axis.

According to one aspect, chi rotation about the chi rotation axis may be performed dependently on the rotation about the theta rotation axis.

According to one aspect, phi rotation about the phi rotation axis may be performed dependently on the rotation about the theta rotation axis and the chi rotation axis.

According to one aspect, the irradiation of the laser beam may be configured such that the laser beam passes through a rotation center (RC) where the theta rotation axis, the 2-theta rotation axis, the chi rotation axis, and the phi rotation axis intersect, and is orthogonal to the 2-theta rotation axis.

According to one aspect, the laser beam may be a visible light.

According to one aspect, a position of 2-theta rotation where a beam of maximum intensity is detected by the beam sensor may be set as a zero point.

According to one aspect, the irradiation of the laser beam may be configured to irradiate the laser beam onto a center of the boundary between the first surface and the second surface of the measurement target gemstone.

According to one aspect, the irradiation of the laser beam may be configured to irradiate the laser beam onto the rotation center (RC).

According to one aspect, the mounting of the gemstone sample may further include adjusting so that a center of the boundary between the first surface and the second surface is positioned at the rotation center based on at least one of: a first camera having a sensor surface perpendicular to the 2-theta rotation axis or a second camera having a sensor surface parallel to the 2-theta rotation axis and the laser beam.

According to one aspect, the measuring may include measuring an angle of the first diffraction component corresponding to the first surface based on the beam sensor, measuring an angle of the second diffraction component corresponding to the second surface based on the beam sensor, and determining the angular difference based on the angle of the first diffraction component and the angle of the second diffraction component.

According to one aspect, the measuring may be configured to calculate an angle between the first surface and the second surface based on the following equation.

$$Angle between surfaces = 180 - 0.5 * ( angle difference )$$

In order to achieve the above-described objects, according to one embodiment of the present disclosure, there is provided a universal gemstone cut identification device, including: a gemstone sample support for mounting a cut gemstone sample; a light source configured to irradiate a laser beam onto a boundary between a first surface and a second surface of a measurement target gemstone; and a controller configured to measure an angle between the first surface and the second surface based on an angular difference between a first diffraction component and a second diffraction component of the laser beam diffracted from the boundary.

In order to achieve the above-described objects, according to one embodiment of the present disclosure, there is provided a computer-readable storage medium containing instructions executable by a processor of a computer, in which the instructions, when executed by the processor, cause the processor to: control such that a laser beam is irradiated onto a boundary between a first surface and a second surface of a measurement target gemstone; and measure an angle between the first surface and the second surface based on an angular difference between a first diffraction component and a second diffraction component of the laser beam diffracted from the boundary.

The disclosed technology may have the following effects. However, this does not mean that a specific embodiment should include all or only the following effects, and thus the scope of the disclosed technology should not be construed as being limited thereby.

According to the universal gemstone cut identification method and device according to one embodiment of the present disclosure described above, the angle between the cut surfaces of a gemstone can be measured using a diffraction analysis principle, thereby allowing the angle between the measurement target surfaces of the gemstone to be measured with simplified computation and low-cost equipment, and enabling quantitative and numerical evaluation of the gemstone cutting.

More specifically, the angle between cut surfaces for gemstones such as diamonds can be automatically measured, and quantitative and numerical evaluation of diamond cutting is possible. In the accuracy of cutting, it is possible to automatically measure the angle between cut surfaces within a fairly accurate range, for example, within +0.05°.

Therefore, it is possible to quantify the conventional qualitative diamond cut evaluation index, and objective and numerical diamond cut evaluation is possible. Through this, it is possible to improve the customer trust of the jewelry seller, and the effect of increasing sales due to the improvement of customer trust can be expected. In addition, it is possible to prevent and resolve disputes related to diamond certificates in advance.

In addition, unlike conventional equipment using 3D morphology, or the like, the universal gemstone cut identification device of one embodiment of the present disclosure can have a simplified device size similar to that of a desktop, and can simplify data processing by using automated measurement and the laws of physics. By utilizing beam alignment technology related to scattering experiments, data processing can be significantly simplified and measurement accuracy can be improved, thereby providing cost advantages and enabling the deployment of non-experts for operation.

### BRIEF DESCRIPTION OF THE DRAWINGS

FIG. 1 illustrates a form and evaluation items of an ideal model of a diamond.

FIG. 2 illustrates a tool for visually distinguishing an angle between surfaces of a gemstone according to a conventional technique.

FIG. 3 is an exemplary diagram of a single crystal diffraction device.

FIG. 4 illustrates a procedure for universal gemstone cut identification according to one embodiment of the present disclosure.

FIG. 5 illustrates an exemplary form of a universal gemstone cut identification device according to one embodiment of the present disclosure.

FIG. 6 illustrates the form of a diffraction component according to the incidence of a laser beam.

FIG. 7 is a conceptual diagram of measuring the angle between cut surfaces based on the angle difference between the diffraction components.

FIG. 8 is a flow chart of a universal gemstone cut identification method according to one embodiment of the present disclosure.

FIG. 9 is a detailed flow chart of the step for measuring an angle between surfaces in FIG. 8.

FIG. 10 is a block diagram illustrating the configuration of the universal gemstone cut identification device according to one embodiment of the present disclosure.

FIG. 11 illustrates an exemplary implementation form of the universal gemstone cut identification device according to one embodiment of the present disclosure.

FIG. 12 is a perspective view of a gemstone cut identification device of FIG. 11.

FIG. 13 is an example of a gemstone sample photograph including the measurement result of an angle between surfaces for the gemstone sample.

FIG. 14 is a graph of the measurement result of an angle between surfaces for the gemstone sample.

FIG. 15 is a block diagram illustrating an exemplary configuration of a computing device on which the universal gemstone cut identification method according to one embodiment of the present disclosure may be performed.

### DETAILED DESCRIPTION

The present disclosure may have various modifications and embodiments, and specific embodiments are illustrated in the drawings and described in detail.

However, this is not intended to limit the present disclosure to specific embodiments, but should be understood to include all modifications, equivalents, or substitutes included in the spirit and technical scope of the present disclosure.

The terms first, second, or the like may be used to describe various components, but the components should not be limited by the terms. The terms are only used to distinguish one component from another. For example, without departing from the scope of the present disclosure, the first component may be referred to as the second component, and similarly, the second component may also be referred to as the first component. The term and/or includes any combination of a plurality of related described items or any item among a plurality of related described items.

When it is said that a component is “coupled” or “connected” to another component, it should be understood that it may be directly coupled or connected to that other component, but that there may be other components in between. Meanwhile, when it is said that a component is “directly coupled” or “directly connected” to another component, it should be understood that there are no other components in between.

The terminology used in this application is only used to describe specific embodiments and is not intended to limit the present disclosure. The singular expression includes the plural expression unless the context clearly indicates otherwise. In this application, it should be understood that the terms “include” or “have” and the like are intended to specify the presence of a feature, number, step, operation, component, part or combination thereof described in the specification, but do not exclude in advance the possibility of the presence or addition of one or more other features, numbers, steps, operations, components, parts or combinations thereof.

Unless otherwise defined, all terms used herein, including technical or scientific terms, have the same meaning as commonly understood by one of ordinary skill in the art to which this disclosure belongs. Terms defined in commonly used dictionaries, such as those defined in common dictionaries, should be interpreted as having a meaning consistent with the meaning they have in the context of the relevant art, and will not be interpreted in an idealized or overly formal sense unless expressly defined in this application.

Hereinafter, with reference to the attached drawings, a preferred embodiment of the present disclosure will be described in more detail. In order to facilitate an overall understanding in describing the present disclosure, the same reference numerals are used for the same components in the drawings, and redundant descriptions of the same components are omitted.

As mentioned above, gemstones such as diamonds may be evaluated and graded and their value may be determined by various evaluation criteria. In fact, gemstones including diamonds are evaluated for their quality by a designated appraisal institution, and the value of the gemstone is determined by the contents of the appraisal certificate. The Gemological Institute of America (GIA) in the United States has the greatest influence in terms of tradition and credibility, and the GIA has established the 4C standard as a standard for evaluating diamonds.

The 4C, which is the criteria for evaluating gemstones, includes Color, Clarity, Carat Weight, and Cut. For Color, the GIA classifies the color grade from D (completely colorless) to Z (pale yellow or brown). Completely colorless diamonds are very rare, and most diamonds used in jewelry have a pale yellow or brown hue. The color grades are determined by comparison to a reference stone, and alphabetic grades can indicate a range of colors. Some diamonds emit visible light when exposed to ultraviolet light, which is called fluorescence and is sometimes given a certain level of consideration.

For the clarity, the GIA classifies gemstones into 11 grades, ranging from flawless to 13. The clarity indicates the relative absence of clarity features (inclusion and blemish) in a gemstone. The inclusion is a feature included completely within the diamond or extending from the surface to the interior, while the blemish is a feature confined to the surface of the diamond. Flawless [Flawless] refers to a grade that no inclusions or blemishes are visible to a skilled grader under 10× magnification. Internally Flawless [IF] indicates a grade in which no inclusions are present, but only minor blemishes can be observed. Very, Very Slightly Included [VVS1 and VVS2] indicate that a gemstone contains very fine inclusions that are very difficult to find, while Very Slightly Included [VS1 and VS2] indicate that a gemstone contains very small inclusions that are somewhat easier to find. Slightly included [SI1 and SI2] indicate grades that contain prominent inclusions that are easy to find, while included [II, 12, and I3] indicate grades that contain obvious inclusions.

The Carat Weight refers to the weight of a diamond. That is, the weight of a diamond is expressed in carats, and 1 carat is equal to 0.2 grams (g).

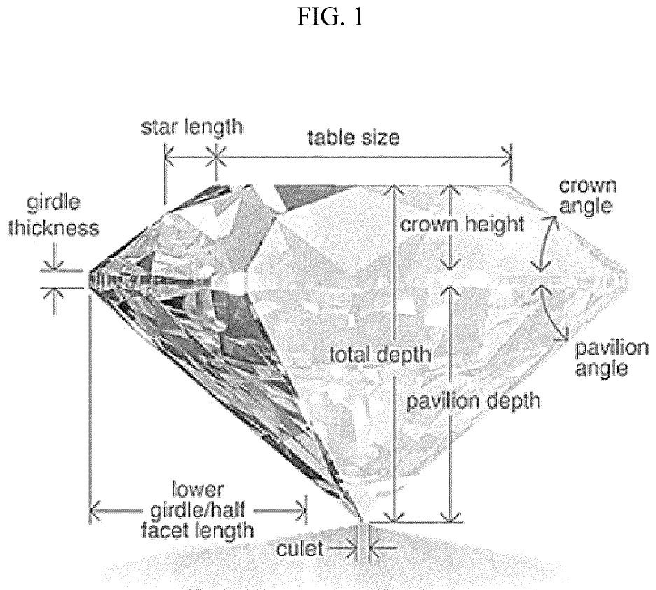

Finally, for the cut, the GIA divides the cut grade from Excellent to Poor and provides a cut grade for standard round brilliant diamonds in D to Z color ranges. The quality of a diamond is determined by complex factors such as the path of light striking the surface, the degree of light penetration, and the form of reflection. Brightness refers to the harmony of all white light reflected from the surface and interior of the diamond, and Fire refers to the phenomenon in which light appears to burn like a flame in a diamond. Scintillation refers to the flash of light that appears when a diamond, a light source, or an observer moves. FIG. 1 illustrates the form and evaluation items of an ideal model of a diamond. As illustrated in FIG. 1, research on a mathematically ideal diamond model is already underway, and each portion of the diamond may be given a name such as table, crown, and pavilion, and evaluation may be made based on the ideal angles and proportions of each portion, consistency, or the like.

Although specific evaluation criteria are mainly used for the appraisal of gemstones such as diamonds, recently, claims for alternative appraisal institutions or independent appraisal standards other than the GIA have been emerging in various regions, including Europe, India, and China.

Furthermore, with the development of artificial diamond production technology, diamonds of several carats have also begun to be synthesized, and with advancements in mining and exploration technologies, the extraction volume of natural rough diamonds has also been exhibiting a steady increase. Therefore, the production and market of natural and artificial diamonds are expected to increase significantly, but the evaluation criteria for diamonds are criticized as being abstract/subjective/non-quantitative. In addition, the diamond market is characterized by a closed evaluation and price determination process.

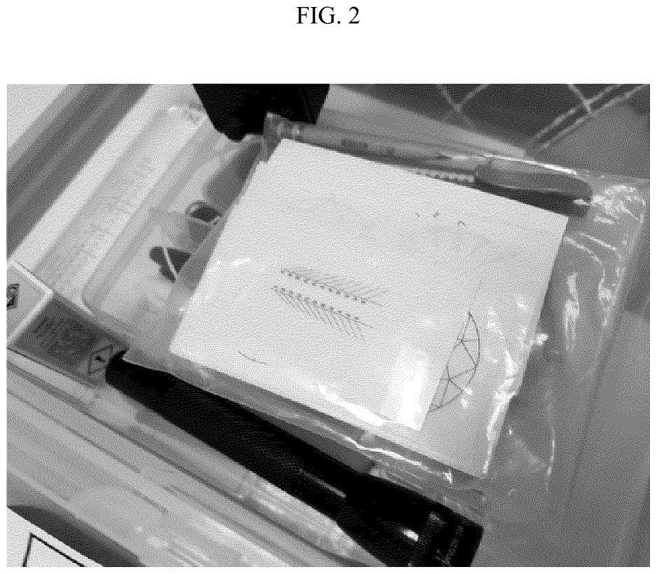

That is, although the production and distribution volumes of gemstones, in terms of both natural and synthetic diamonds, are expected to continue to increase, there has been continuous debate about the closed appraisal and distribution process for the evaluation and appraisal procedures of diamonds, and the need for possessing independent appraisal technology is increasingly being recognized. Conventional traditional appraisal methods rely heavily on skilled professionals; however, issues have been raised regarding their repeatability and fairness. FIG. 2 illustrates a tool for visually distinguishing an angle between surfaces of a gemstone according to conventional technique. As illustrated in FIG. 2, conventional appraisals using primitive tools require a great deal of expertise from appraisers, and are nevertheless non-quantitative and may present issues in terms of repeatability and fairness. Recently, sellers of gemstones such as diamonds have shown a demand for possessing diamond appraisal tools that allow for simple and independent evaluation.

In relation to this, there are attempts at automated evaluation as an appraisal method that can evaluate the grade of a gemstone, unlike traditional evaluation methods, but 3D morphology-based technology, which is a similar automated technology, requires considerably expensive equipment for implementation and has the problem of requiring a large amount of computation.

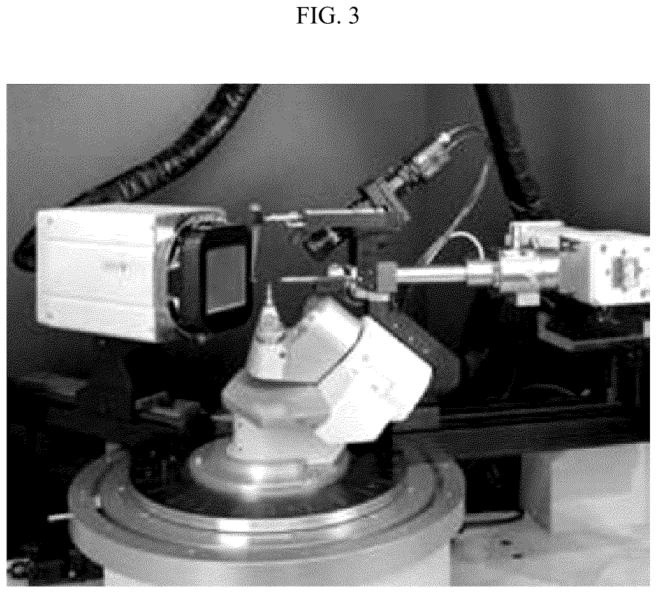

The present disclosure is intended to solve such problems, that enables quantitative and numerical evaluation of gemstone cutting by measuring an angle between cut surfaces of a gemstone using a diffraction analysis principle, thereby allowing the angle between the measurement target surfaces of the gemstone to be measured with only low-cost equipment and simplified computation. FIG. 3 is an exemplary diagram of a single crystal diffraction device, and according to embodiments of the present disclosure, by utilizing some of the features of diffraction analysis as exemplified in FIG. 3, it enables more convenient and quantitative evaluation of gemstone cutting.

More specifically, the angle between cut surfaces for gemstones such as diamonds can be automatically measured, and quantitative and numerical evaluation of diamond cutting is possible. In the accuracy of cutting, it is possible to automatically measure the angle between cut surfaces within a fairly accurate range, for example, within +0.05°.

Therefore, it is possible to quantify the conventional qualitative diamond cut evaluation index, and objective and numerical diamond cut evaluation is possible. Through this, it is possible to improve the customer trust of the jewelry seller, and the effect of increasing sales due to the improvement of customer trust can be expected. In addition, it is possible to prevent and resolve disputes related to diamond certificates in advance.

In addition, unlike the conventional equipment using 3D morphology, or the like, the universal gemstone cut identification device according to one embodiment of the present disclosure can have a simplified device size similar to that of a desktop, and can simplify data processing by using automated measurement and the laws of physics. By utilizing beam alignment technology related to scattering experiments, data processing can be significantly simplified and measurement accuracy can be improved, thereby providing cost advantages and enabling the deployment of non-experts for operation.

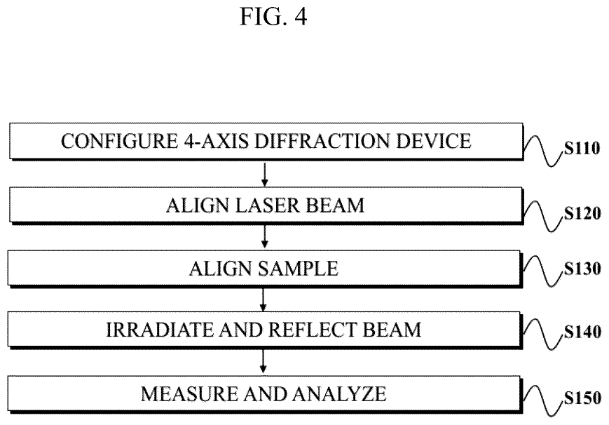

FIG. 4 illustrates a procedure for universal gemstone cut identification according to one embodiment of the present disclosure. Hereinafter, a gemstone cut identification process according to one embodiment of the present disclosure will be described in more detail with reference to FIG. 4.

As illustrated in FIG. 4, the gemstone cut identification process according to one embodiment of the present disclosure may proceed through at least one of the following procedures: configuring a 4-axis diffraction device (Step 110), aligning a laser beam (Step 120), aligning a sample (Step 130), irradiating and reflecting a beam (Step 140), or measuring and analyzing (Step 150). Through these steps, the angle between cut surfaces of a gemstone, such as a diamond, on which cutting processing has been performed can be measured.

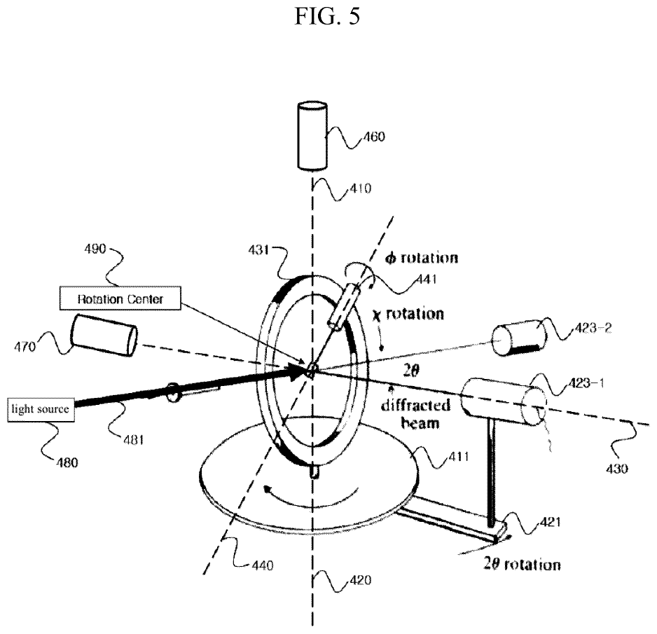

First, for the gemstone cut identification according to one embodiment of the present disclosure, the 4-axis diffraction device may be configured (Step 110). According to one aspect, some features of the 4-axis diffraction device, which can also be used for diffraction analysis as exemplified in FIG. 3, may be utilized. In this regard, FIG. 5 illustrates an exemplary form of the universal gemstone cut identification device according to one embodiment of the present disclosure. Hereinafter, the 4-axis rotating device may also be referred to as a “gemstone sample support.”

As illustrated in FIG. 5, the universal gemstone cut and identification device according to one embodiment of the present disclosure may be provided with the gemstone sample support. The gemstone sample support may be a 4-axis rotating device having four rotation axes including a theta rotation axis 410, a 2-theta rotation axis 420, a chi rotation axis 430, and a phi rotation axis 440.

Here, the theta rotation axis 410 and the 2-theta rotation axis 420 may be configured to rotate about the same axis. That is, the theta rotation and the 2-theta rotation are based on the same rotation axis, but the theta rotation and the 2-theta rotation may be performed independently of each other. For example, a theta rotation body 411 may rotate about the theta rotation axis 410, and independently of this, a 2-theta rotating body 421 may be configured to rotate about the 2-theta rotation axis 420 that is the same as the theta rotation axis 410.

The chi rotation axis 430 may be configured to be orthogonal to the theta rotation axis 410. A chi rotation body 431 may be configured to rotate about the chi rotation axis 430. Here, one plane may be created due to the two straight lines of the chi rotation axis 430 and the theta rotation axis 410.

The phi rotation axis 440 may be configured to pass through the intersection point of the theta rotation axis 410 and the chi rotation axis 430. According to one aspect, the phi rotation axis 440 may be configured to be orthogonal to the chi rotation axis 430 and the theta rotation axis 410 and to lie on a plane formed by the chi rotation axis 430 and the theta rotation axis 410.

According to one aspect, the chi rotation about the chi rotation axis 430 may be performed dependently on the rotation about the theta rotation axis 410. In addition, the phi rotation about the phi rotation axis 440 may be performed dependently on the rotation about the theta rotation axis 410 and the chi rotation axis 430. For example, a motor for the chi rotation may be disposed above a motor for the theta rotation, and a motor for the phi rotation may be disposed above that. That is, the components for the chi and phi rotations may be configured to rotate together by the theta rotation, and the components for the phi rotation may be configured to rotate together by the chi rotation. Accordingly, the phi rotation may be configured to be dependent on the chi and theta rotations, and the chi rotation may be configured to be dependent on the theta rotation.

As previously discussed, the 2-theta rotation about the 2-theta rotation axis 420 may be performed independently of the rotations of the theta rotation axis 410, the chi rotation axis 430, and the phi rotation axis 440. That is, the 2-theta rotation may be configured to be independent of the remaining three rotations. According to one aspect, a beam sensor 423-1 for detecting the laser beam may be mounted on the 2-theta rotating body 421 rotating about the 2-theta rotation axis 420.

For the four rotation axes of the 4-axis diffraction device, alignment of the rotation center (RC) may be performed. The rotation center may refer to a virtual point where the four rotation axes intersect, and the alignment of the rotation center may indicate aligning the respective rotation axes of the 4-axis diffraction device such that the four rotation axes actually intersect at a single virtual point. The configuration of the 4-axis diffraction device can be completed through the alignment of the rotation centers. The 4-axis diffraction device may utilize a goniometer of a conventional diffraction analyzer.

Referring again to FIG. 4, alignment of the laser beam for the gemstone cut identification according to one embodiment of the present disclosure (Step 120) may be performed. As illustrated in FIG. 5, the apparatus for gemstone cut identification according to one embodiment of the present disclosure may include a light source 480 that emits a laser beam 481. Here, causing the laser beam 481 emitted from the light source to pass through the rotation center and be perpendicular to the 2-theta rotation axis 420 may be referred to as laser beam alignment. More specifically, according to one aspect, the light source 480 may be disposed such that the laser beam emitted from the light source 480 passes through a rotation center (RC) 490 where the theta rotation axis 410, the 2-theta rotation axis 420, the chi rotation axis 430, and the phi rotation axis 440 intersect, and is orthogonal to the 2-theta rotation axis 420. According to one aspect, the cross-section of the laser beam may be circular, and the center of such a circle may be made to coincide with the rotation center. In other embodiments, the midpoint of the cross-section of the laser beam may be made to coincide with the rotation center.

According to one aspect, the position 423-1 in the 2-theta rotation at which the beam with the maximum intensity is detected by the beam sensors 423-1 and 423-2 may be configured to be set as the zero point. For example, the beam sensor may be mounted on the 2-theta rotating body 421 and configured to perform the 2-theta rotation, and may move within the 2-theta rotation range including, for example, the first position 423-1 or the second position 423-2. While performing the 2-theta rotation within this movement range, the position (for example, 423-1) at which the beam sensor records the maximum value may be designated as the 0 of the 2-theta.

According to one aspect, the laser beam may be visible light. The beam sensor may be a sensor that detects visible light. According to another aspect, the laser beam may have various wavelengths, and the beam sensor may be configured to detect a corresponding laser. According to another aspect, it should be understood that despite the use of terms such as the laser beam or beam sensor, emitters and detectors that may generate diffraction and detect the diffraction, such as the diffraction analyzer that emits X-rays or neutrons and detects them, are also included in the scope of the present disclosure.

Referring again to FIG. 4, the alignment of a gemstone sample for gemstone cut identification according to one embodiment of the present disclosure (Step 130) may be performed. As illustrated in FIG. 5, the device for the gemstone cut identification according to one embodiment of the present disclosure may include at least one of a first camera 460 or a second camera 470.

According to one embodiment of the present disclosure, the sample alignment may be configured to irradiate the laser beam onto the center of the boundary between the first surface and the second surface of the measurement target gemstone. In addition, the sample alignment may be configured to irradiate the laser beam onto the rotation center (RC). Specifically, the sample may be aligned such that the midpoint of the line segment where one surface and another surface of the sample intersect becomes the center of the laser beam, that is, the rotation center.

In performing the sample alignment, at least one of the first camera 460 or the second camera 470 may be used. For example, the first camera 460 may be disposed so that a sensor surface is perpendicular to the 2-theta rotation axis. The second camera 470 may be disposed so that a sensor surface is parallel to the 2-theta rotation axis and the laser beam. Based on at least one of the first camera 460 and the second camera 470, the position of the measurement target gemstone may be adjusted so that the center of the boundary between the first surface and the second surface of the measurement target gemstone is positioned at the rotation center. That is, by using at least one of the first camera and the second camera, it is possible to recognize how far the sample is from the rotation center and perform the alignment.

Referring back to FIG. 4, once all alignments are completed, beam irradiation and reflection (Step 140) may be performed. The light source 480 may be operated so that the laser beam 481 is irradiated onto the measurement target gemstone and is reflected therefrom.

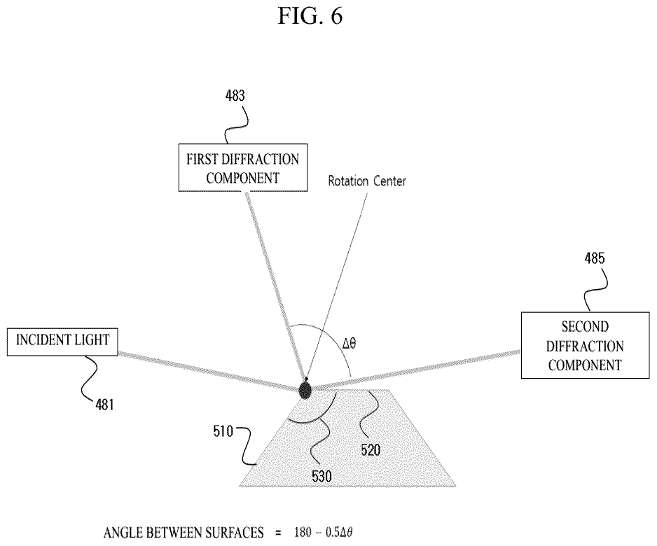

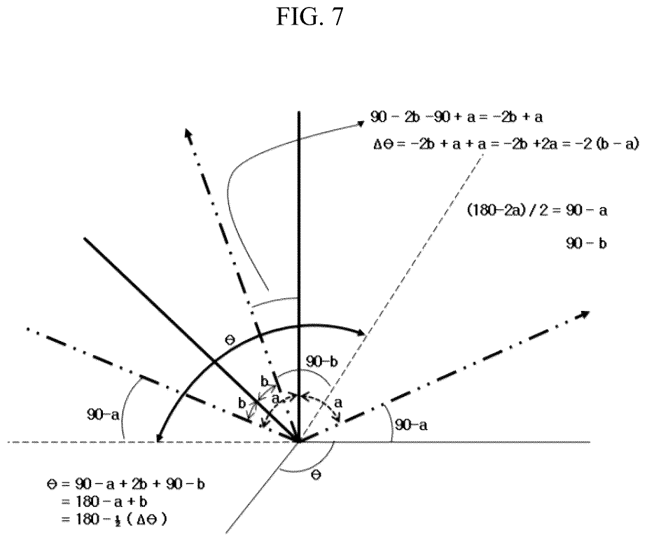

Thereafter, measurement and analysis (Step 150) may be performed. According to one aspect of the present disclosure, the angle between the first surface and the second surface may be measured based on the angular difference between a first diffraction component and a second diffraction component of the laser beam 481 diffracted from the boundary. In this regard, FIG. 6 illustrates the form of the diffraction component according to the incidence of the laser beam, and FIG. 7 is a conceptual diagram of the angle measurement between the cut surfaces based on the angular difference between the diffraction components. As illustrated in FIG. 6, the laser beam 481 from the light source 480 may be incident as incident light on the boundary between a first surface 510 and a second surface 520 of the measurement target gemstone. According to one aspect, the angle 530 between the first surface 510 and the second surface 520 of the measurement target gemstone may be measured by using the angular difference between the first diffraction component 483 by one of the first surface 510 and the second surface 520 and the second diffraction component 485 by the other.

For example, more specifically, by measuring an angle of the first diffraction component 483 corresponding to the first surface based on the beam sensor, and by measuring the angle of the second diffraction component 485 corresponding to the second surface based on the beam sensor, the angle 530 between the first surface 510 and the second surface 520 may be determined based on the angle of the first diffraction component and the angle of the second diffraction component.

According to one aspect, it can be configured to calculate the angle between the first surface and the second surface based on the following equation.

$$Angle between surfaces = 180 - 0.5 * ( angle difference between first diffraction component and second diffraction component )$$

FIG. 7 is a conceptual diagram of measuring the angle between cut surfaces based on the angular difference between the diffraction components. As more specifically illustrated in FIG. 7, the angle θ between the first surface and the second surface may be calculated using 40, which is the angular difference between the first diffraction component and the second diffraction component. For example, the angle θ between the first surface and the second surface may be calculated by subtracting one-half of the value of 40, which is the angular difference between the first diffraction component and the second diffraction component, from 180 degrees.

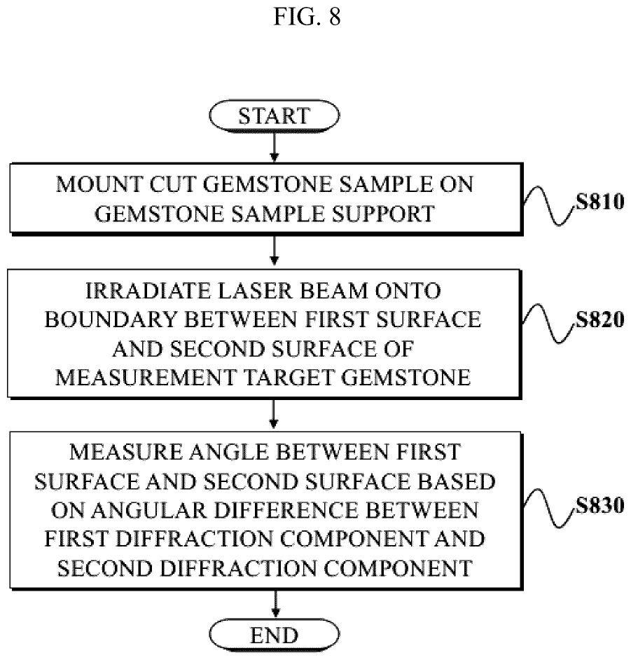

FIG. 8 is a flow chart of a universal gemstone cut identification method according to one embodiment of the present disclosure. As illustrated in FIG. 8, in the universal gemstone cut identification method according to one embodiment of the present disclosure, the cut gemstone sample may be mounted on the gemstone sample support (Step 810). For example, the gemstone sample support may be a 4-axis rotating device having four rotation axes including a theta rotation axis, a 2-theta rotation axis, a chi rotation axis, and a phi rotation axis. Here, the theta rotation axis and the 2-theta rotation axis may be configured to rotate about the same axis, the chi rotation axis may be configured to be orthogonal to the theta rotation axis, and the phi rotation axis may be configured to pass through the intersection point of the theta rotation axis and the chi rotation axis and to be orthogonal to the chi rotation axis.

As described above, the 2-theta rotation about the 2-theta rotation axis may be performed independently of the rotations about the theta rotation axis, the chi rotation axis, and the phi rotation axis, the chi rotation about the chi rotation axis may be performed dependently on the rotation about the theta rotation axis, and the phi rotation about the phi rotation axis may be performed dependently on the rotations about the theta rotation axis and the chi rotation axis. In addition, the beam sensor that detects the laser beam may be mounted on the 2-theta rotating body rotating about the 2-theta rotation axis.

The mounting of the gemstone sample may include adjusting such that the center of the boundary between the first surface and the second surface is positioned at the rotation center based on at least one of the first camera having the sensor surface perpendicular to the 2-theta rotation axis or the second camera having the sensor surface parallel to the 2-theta rotation axis and the laser beam.

Referring again to FIG. 8, the laser beam may be irradiated onto the boundary between the first surface and the second surface of the measurement target gemstone (Step 820). Here, the laser beam may pass through the rotation center (RC) where the theta rotation axis, the 2-theta rotation axis, the chi rotation axis, and the phi rotation axis intersect, and may be irradiated so as to be orthogonal to the 2-theta rotation axis. The position in the 2-theta rotation at which the beam of the maximum intensity is detected by the beam sensor may be configured to be set as the zero point. Meanwhile, the laser beam may be irradiated onto the center of the boundary between the first surface and the second surface of the measurement target gemstone. In addition, the laser beam may be configured to be irradiated onto the rotation center (RC).

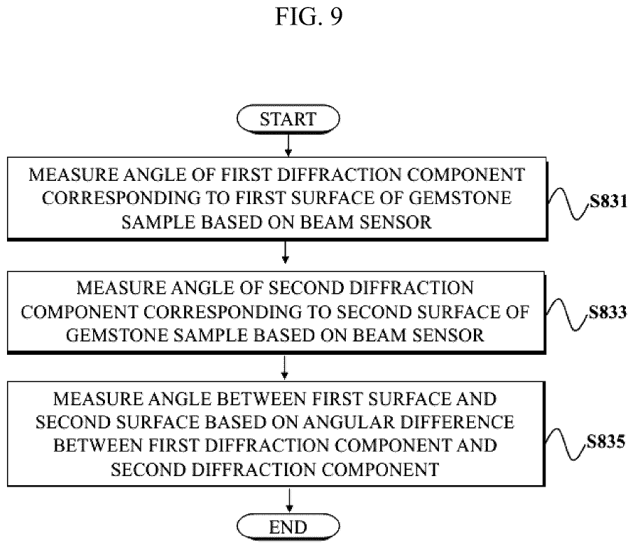

Referring back to FIG. 8, the angle between the first surface and the second surface may be measured based on the angular difference between the first diffraction component and the second diffraction component of the laser beam diffracted from the boundary (Step 830). More specifically, as illustrated in FIG. 9, the step may include measuring the angle of the first diffraction component corresponding to the first surface based on the beam sensor (Step 831), measuring the angle of the second diffraction component corresponding to the second surface based on the beam sensor (Step 833), and determining the angular difference based on the angle of the first diffraction component and the angle of the second diffraction component (Step 835). The angle between the first surface and the second surface, which are cut surfaces of the measurement target gemstone, can be measured based on the angular difference between the first diffraction component and the second diffraction component. According to one aspect, it can be configured to calculate the angle between the first surface and the second surface based on the following equation.

$$Angle between surfaces = 180 - 0.5 * ( angle difference )$$

The individual procedures of the universal gemstone cut identification method according to one embodiment of the present disclosure may include at least some of the technical features described in relation to at least one of the above-described gemstone cut identification procedures of the present disclosure, namely, configuring the 4-axis diffraction device (Step 110), aligning the laser beam (Step 120), aligning the sample (Step 130), irradiating and reflecting the beam (Step 140), or measuring and analyzing (Step 150).

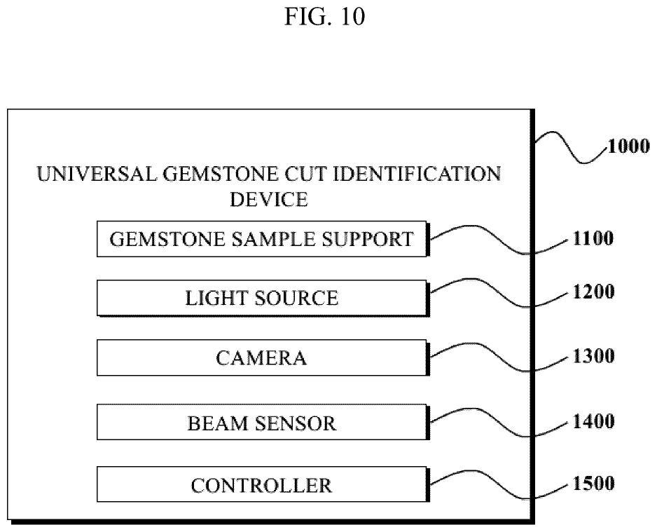

FIG. 10 is a block diagram illustrating the configuration of the universal gemstone cut identification device according to one embodiment of the present disclosure. As illustrated in FIG. 10, a universal gemstone cut identification device 1000 according to one embodiment of the present disclosure may include a gemstone sample support 1100, a light source 1200, a camera 1300, a beam sensor 1400, and a controller 1500.

The gemstone sample support 1100 may mount the cut gemstone sample, and the light source 1200 may be configured to irradiate a laser beam onto the boundary between the first surface and the second surface of the measurement target gemstone. The controller 1500 may be configured to measure the angle between the first surface and the second surface based on the angular difference between the first diffraction component and the second diffraction component of the laser beam diffracted from the boundary. The controller 1500 may be implemented by, for example, a computing device.

Meanwhile, the individual configuration and technical features of the universal gemstone cut identification device according to one embodiment of the present disclosure may include at least some of the technical features described in relation to at least one of the above-described gemstone cut identification procedures of the present disclosure, namely, configuring the 4-axis diffraction device (Step 110), aligning the laser beam (Step 120), aligning the sample (Step 130), irradiating and reflecting the beam (Step 140), or measuring and analyzing (Step 150).

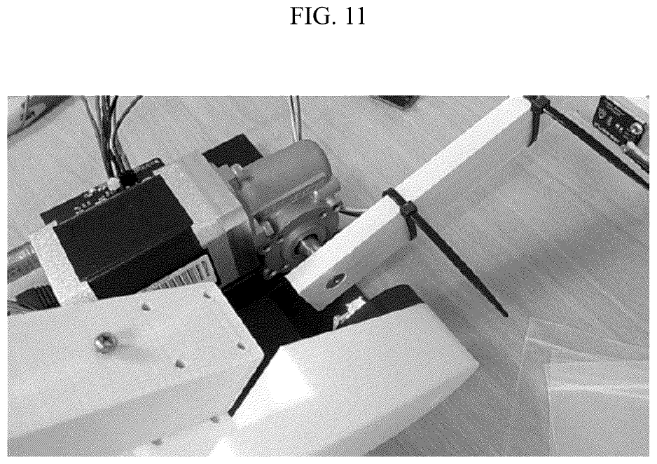

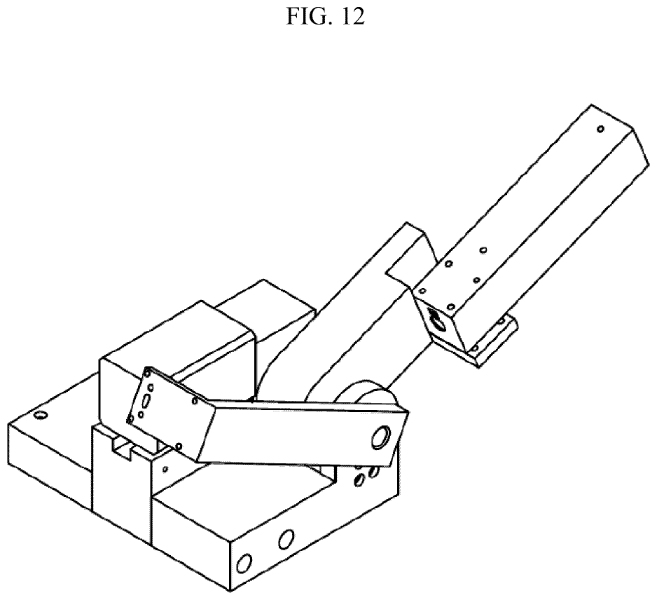

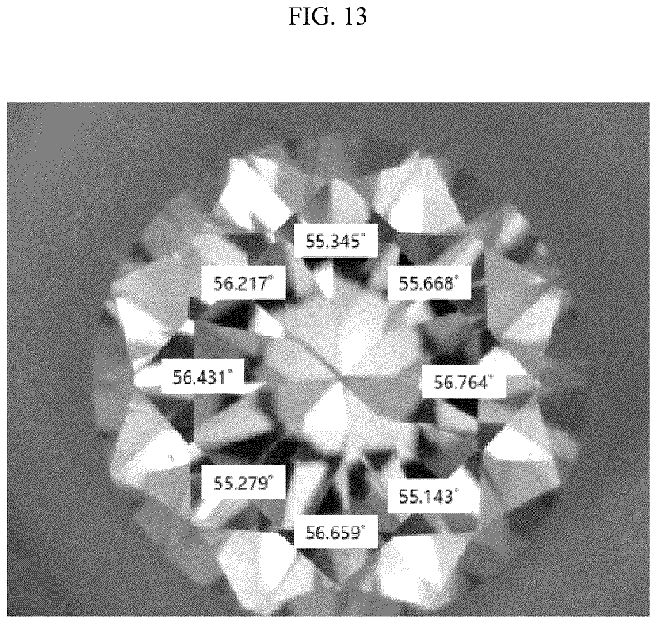

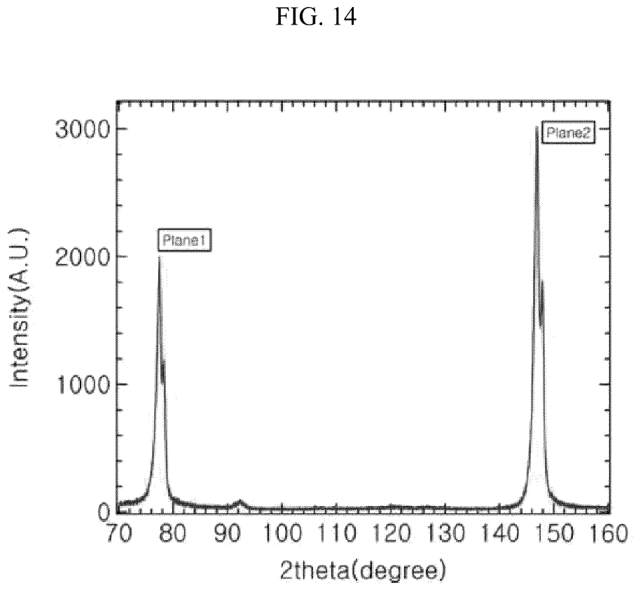

FIG. 11 illustrates an exemplary implementation form of the universal gemstone cut and identification device according to one embodiment of the present disclosure, and FIG. 12 is a perspective view of the gemstone cut and identification device of FIG. 11. As illustrated in FIGS. 11 and 12, the universal gemstone cut identification device according to one embodiment of the present disclosure can operate and measure angles in an environment similar to an environment in which a jewelry seller is positioned. More specifically, FIG. 13 is an exemplary diagram of a gemstone sample photograph including a measurement result of an angle between surfaces for the gemstone sample, and FIG. 14 is a graph for the measurement result of the angle between surfaces for the gemstone sample. As illustrated in FIGS. 13 and 14, measurement of the angle between cut surfaces of an actual measurement target gemstone is possible.

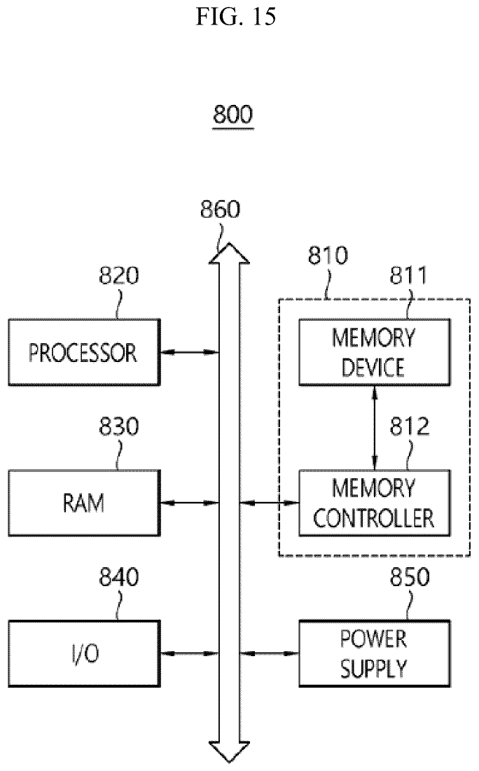

FIG. 15 is a block diagram illustrating an exemplary configuration of a computing device on which the universal gemstone cut identification method according to one embodiment of the present disclosure can be performed. Referring to FIG. 15, a computing system 800 may include a flash storage 810, a processor 820, a RAM 830, an input/output device 840, and a power supply 850. In addition, the flash storage 810 may include a memory device 811 and a memory controller 812. Meanwhile, although not illustrated in FIG. 8, the computing system 800 may further include ports that can communicate with a video card, a sound card, a memory card, a USB device, or the like, or communicate with other electronic devices.

The computing system 800 may be implemented as a personal computer or as a portable electronic device such as a laptop computer, a mobile phone, a personal digital assistant (PDA), and a camera.

The processor 820 may perform specific calculations or tasks. According to one embodiment, the processor 820 may be a micro-processor, a central processing unit (CPU). The processor 820 may communicate with the RAM 830, the input/output device 840, and the flash storage 810 via a bus 860, such as an address bus, a control bus, and a data bus. The flash storage 810 may be implemented using the flash storage of the embodiments illustrated in FIGS. 5 to 7.

According to one embodiment, the processor 820 may also be connected to an expansion bus, such as a Peripheral Component Interconnect (PCI) bus.

The RAM 830 may store data required for the operation of the computing system 800. For example, any type of random-access memory including DRAM, mobile DRAM, SRAM, PRAM, FRAM, MRAM, and RRAM can be used as the RAM 830.

The input/output device 840 may include input means such as a keyboard, keypad, mouse, or the like, and output means such as a printer, display, or the like. The power supply 850 may supply an operating voltage necessary for the operation of the computing system 800.

The method according to the present disclosure described above may be implemented as a computer-readable code on a computer-readable recording medium. The computer-readable recording medium includes all kinds of recording media that store data that can be deciphered by a computer system. For example, as the computer-readable recording medium, there may be a Read Only Memory (ROM), a Random Access Memory (RAM), a magnetic tape, a magnetic disk, a flash memory, an optical data storage device, and the like. In addition, the computer-readable recording medium may be distributed to computer systems connected to a computer communication network, and stored and executed as a code that can be read in a distributed manner.

Although the present disclosure has been described with reference to the drawings and embodiments, it does not mean that the scope of protection of the present disclosure is limited by the drawings or embodiments, and it will be understood that a person skilled in the art can variously modify and change the present disclosure without departing from the spirit and scope of the present disclosure as described in the claims below.

Specifically, the described features may be implemented in digital electronic circuitry, or in computer hardware, firmware, or combinations thereof. The features may be implemented in a computer program product embodied in a storage device, for example, in a machine-readable storage device, for execution by a programmable processor. Moreover, the features may be implemented by a programmable processor executing a program of instructions for performing the functions of the described embodiments by operating on input data and generating output. The described features may be implemented in one or more computer programs executable on a programmable system comprising at least one programmable processor, at least one input device, and at least one output device coupled to receive data and instructions from a data storage system, and to transmit data and instructions to the data storage system. The computer program comprises a set of instructions that can be used directly or indirectly within a computer to perform a particular operation for a given result. A computer program may be written in any programming language, including compiled or interpreted languages, and may be used in any form, including as a module, component, subroutine, or other unit suitable for use in another computing environment, or as a standalone program.

Suitable processors for execution of the program of instructions include, for example, both general-purpose and special-purpose microprocessors, and either a single processor or multiple processors of another type of computer. Moreover, suitable storage devices for implementing the computer program instructions and data implementing the described features include all forms of nonvolatile memory, including, for example, semiconductor memory devices such as EPROM, EEPROM, and flash memory devices, magnetic devices such as internal hard disks and removable disks, magneto-optical disks, and CD-ROM and DVD-ROM disks. The processor and memory may be integrated within, or added to by, application-specific integrated circuits (ASICs).

Although the present disclosure described above has been described based on a series of functional blocks, it is not limited to the above-described embodiments and the attached drawings, and it will be apparent to those skilled in the art that various substitutions, modifications, and changes can be made without departing from the technical spirit of the present disclosure.

The combination of the above-described embodiments is not limited to the above-described embodiments, and various combinations may be provided in addition to the above-described embodiments depending on implementation and/or needs.

In the above-described embodiments, the methods are described based on the flowchart as a series of steps or blocks, but the present disclosure is not limited to the order of the steps, and some steps may occur in a different order or simultaneously with other steps described above. In addition, those skilled in the art will understand that the steps illustrated in the flowchart are not exclusive, and other steps may be included, or one or more steps in the flowchart may be deleted without affecting the scope of the present disclosure.

The above-described embodiments include examples of various aspects. Although it is not possible to describe all possible combinations to represent various aspects, those skilled in the art will recognize that other combinations are possible. Accordingly, it is intended that the present disclosure include all other alterations, modifications, and changes that fall within the scope of the following claims.

1. A method for universally identifying gemstone cuts, the method comprising:
mounting a cut gemstone sample on a gemstone sample support;
irradiating a laser beam onto a boundary between a first surface and a second surface of a measurement target gemstone; and
measuring an angle between the first surface and the second surface based on an angular difference between a first diffraction component and a second diffraction component of the laser beam diffracted from the boundary.

2. The method of claim 1, wherein the gemstone sample support is a 4-axis rotating device having four rotation axes including a theta rotation axis, a 2-theta rotation axis, a chi rotation axis, and a phi rotation axis.

3. The method of claim 2, wherein the theta rotation axis and the 2-theta rotation axis are configured to rotate about the same axis,
the chi rotation axis is orthogonal to the theta rotation axis, and
the phi rotation axis passes through an intersection point of the theta rotation axis and the chi rotation axis, and is orthogonal to the chi rotation axis.

4. The method of claim 3, wherein a beam sensor for detecting the laser beam is mounted on a 2-theta rotating body that rotates about the 2-theta rotation axis.

5. The method of claim 4, wherein 2-theta rotation about the 2-theta rotation axis is performed independently of the rotation about the theta rotation axis, the chi rotation axis, and the phi rotation axis.

6. The method of claim 5, wherein chi rotation about the chi rotation axis is performed dependently on the rotation about the theta rotation axis.

7. The method of claim 6, wherein phi rotation about the phi rotation axis is performed dependently on the rotation about the theta rotation axis and the chi rotation axis.

8. The method of claim 2, wherein the irradiation of the laser beam is configured such that the laser beam passes through a rotation center (RC) where the theta rotation axis, the 2-theta rotation axis, the chi rotation axis, and the phi rotation axis intersect, and is orthogonal to the 2-theta rotation axis.

9. The method of claim 8, wherein the laser beam is a visible light.

10. The method of claim 4, wherein a position of 2-theta rotation where a beam of maximum intensity is detected by the beam sensor is set as a zero point.

11. The method of claim 1, wherein the irradiation of the laser beam is configured to irradiate the laser beam onto a center of the boundary between the first surface and the second surface of the measurement target gemstone.

12. The method of claim 8, wherein the irradiation of the laser beam is configured to irradiate the laser beam onto the rotation center (RC).

13. The method of claim 8, wherein the mounting of the gemstone sample further includes adjusting so that a center of the boundary between the first surface and the second surface is positioned at the rotation center, based on at least one of: a first camera having a sensor surface perpendicular to the 2-theta rotation axis or a second camera having a sensor surface parallel to the 2-theta rotation axis and the laser beam.

14. The method of claim 4, wherein the measuring includes measuring an angle of the first diffraction component corresponding to the first surface based on the beam sensor,
measuring an angle of the second diffraction component corresponding to the second surface based on the beam sensor, and
determining the angular difference based on the angle of the first diffraction component and the angle of the second diffraction component.

15. The method of claim 4, wherein the measuring is configured to calculate an angle between the first surface and the second surface based on the following equation:
Angle between surfaces=180−0.5*(angle difference).

16. A universal gemstone cut identification device, comprising:
a gemstone sample support for mounting a cut gemstone sample;
a light source configured to irradiate a laser beam onto a boundary between a first surface and a second surface of a measurement target gemstone; and
a controller configured to measure an angle between the first surface and the second surface based on an angular difference between a first diffraction component and a second diffraction component of the laser beam diffracted from the boundary.

17. A computer-readable storage medium containing instructions executable by a processor of a computer, wherein the instructions, when executed by the processor, cause the processor to:
control such that a laser beam is irradiated onto a boundary between a first surface and a second surface of a measurement target gemstone; and
measure an angle between the first surface and the second surface based on an angular difference between a first diffraction component and a second diffraction component of the laser beam diffracted from the boundary.
